(19) United States
(12) Patent Application Publication
(10) Pub. No.: US 2026/0028245 A1
(43) Pub. Date: Jan. 29, 2026

(54) PROCESS FOR MAKING AN (OXY)HYDROXIDE, AND (OXY)HYDROXIDES

(71) Applicant: BASF SE, Ludwigshafen Am Rhein (DE)

(72) Inventors: Thorsten BEIERLING, Wolfenbuettel (DE); Emre EMMEZ, Ludwigshafen am Rhein (DE); Thomas Michael RYLL, Ludwigshafen am Rhein (DE); Zoltan BAAN, Helsinki (FI); Sven LAUFER, Ludwigshafen am Rhein (DE); Dirk KLINGLER, Ludwigshafen am Rhein (DE)

(21) Appl. No.: 18/995,261

(22) PCT Filed: Jul. 31, 2023
(86) PCT No.: PCT/EP23/71177

§ 371 Date: Jan. 16, 2025

(30) Foreign Application Priority Data
Aug. 11, 2022 (EP) 22189997.4

(51) Int. Cl. C01G 53/84; H01M 4/02

(52) U.S. Cl. CPC C01G 53/84; C01P 2004/32; C01P 2004/51; C01P 2004/61; C01P 2004/62; C01P 2006/40; H01M 2004/028

(57) ABSTRACT

Disclosed herein is a process for making a particulate (oxy)hydroxide of TM where TM refers to a combination of nickel and at least one metal selected from Co and Mn and where the process includes the steps of:
(a) providing one or more aqueous solution(s) (α) containing water-soluble salts of Ni and of at least one transition metal selected from Co and Mn, and, optionally, at least one further metal selected from Ti, Zr, Mo, W, Al, Mg, Nb, and Ta, and an aqueous solution (β) containing an alkali metal hydroxide and, optionally, an aqueous solution (γ) containing a complexing agent, and
(b) combining in a stirred tank reactor solution(s) (α) and solution (β) and, if applicable, solution (γ) in one or more sub-steps, at a pH value in the range of from 10.5 to 12.5 determined at 23° C., thereby creating solid particles of hydroxide, the solid particles being slurried,
where the stirred tank reactor used in step (b) or in at least one of the sub-steps (b) is equipped with a solid-liquid separation device through which mother liquor containing in the range of from 2 mg/l to 20 g/l of slurried particles of hydroxide is withdrawn.

The present invention is directed towards a process for making a particulate (oxy)hydroxide of TM wherein refers to a combination of nickel and at least one metal selected from Co and Mn and wherein said process comprises the steps of:
(a) Providing one or more aqueous solution(s) (α) containing water-soluble salts of Ni and of at least one transition metal selected from Co and Mn, and, optionally, at least one further metal selected from Ti, Zr, Mo, W, Al, Mg, Nb, and Ta, and an aqueous solution (β) containing an alkali metal hydroxide and, optionally, an aqueous solution (γ) containing a complexing agent,
(b) combining in a stirred tank reactor solution(s) (α) and solution (β) and, if applicable, solution (γ) in one or more sub-steps, at a pH value in the range of from 10.5 to 12.5 determined at 23° C., thereby creating solid particles of hydroxide, said solid particles being slurried,
wherein a stirred tank reactor used in step (b) or at least one of the sub-steps (b) is equipped with a solid-liquid separation device through which mother liquor containing slurried particles of hydroxide in the range of from 2 mg/l to 20 g/l is withdrawn.

Lithiated transition metal oxides are currently used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals as carbonates, oxides or preferably as hydroxides that may or may not be basic, for example oxyhydroxides. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—often also referred to as thermal treatment or heat treatment of the precursor—is usually carried out at temperatures in the range of from 600 to 1000° C. During the thermal treatment a solid-state reaction takes place, and the electrode active material is formed. The thermal treatment is performed in the heating zone of an oven or kiln.

To a certain extent, properties of the precursor translate into properties of the respective electrode active material, such as particle size distribution, content of the respective transition metals and more. It is therefore possible to influence the properties of electrode active materials by steering the properties of the precursor.

Cathode active materials—and thus their precursors—with a narrow particle size distribution have been a goal of research. In EP 2 720 305 A, a two-step process is disclosed wherein the pH value is lowered in the second step, the so-called particle growth step, with respect to the first step. In EP 2 818 452 A, a two-step process is disclosed wherein mother liquor is withdrawn in the particle growth step. Care is taken that no solids are withdrawn together with said mother liquor.

It is an objective of the present invention to provide a process that allows the production of a highly spherical precursor with narrow particle size distribution. It was further an objective of the present invention to provide a precursor for an electrode active material with a narrow particle size distribution and excellent sphericity.

Accordingly, the process as defined at the outset has been found, hereinafter also defined as “inventive process” or “process according to the (present) invention”. The inventive process comprises at least two steps, hereinafter also referred to as step (a) and step (b), or—even more briefly—(a), and (b), respectively. The inventive process may include further—optional—steps. Steps (a) and (b) are described in more detail below. By the inventive process, a highly spherical precursor with narrow particle size distribution is obtained.

It has been found that—if in step (b), a certain amount of particles is removed as well through a clarifier—the span of the resultant particulate (oxy)hydroxide of TM is in the range of from 0.20 to 0.33.

The inventive process is a process for making a particulate (oxy)hydroxide of TM. Said particulate (oxy)hydroxide then serves as a precursor for electrode active materials, and it may therefore also be referred to as precursor.

In one embodiment of the present invention, the resultant precursor is comprised of secondary particles that are agglomerates of primary particles. Said primary particles have the shape of platelets.

In one embodiment of the present invention the specific surface (BET) of the resultant precursor is in the range of from 2 to 70 m²/g, determined by nitrogen adsorption, for example in accordance with to DIN-ISO 9277:2003-05. The outgassing temperature is 120° C.

The precursor is an (oxy)hydroxide of TM wherein TM comprises Ni and at least one metal selected from Co and Mn and Al, and, optionally, at least one further metal selected from Ti, Zr, Mo, W, Mg, and Nb.

In one embodiment of the present invention, TM is a combination of metals according to general formula (I)

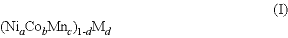

with
a being in the range of from 0.6 to 0.95, preferably from 0.8 to 0.94,
b being in the range of from 0.025 to 0.2, preferably from 0.025 to 0.15,
c being in the range of from zero to 0.2, preferably from zero to 0.15, and
d being in the range of from zero to 0.1,
M is selected from Mg, Al, Ti, Zr, Mo, W, Nb, and Ta,
a+b+c=1, and b+c>zero or M includes Al and d>zero.

In another embodiment of the present invention, TM corresponds to general formula (I a)

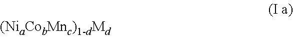

with
a being in the range of from 0.25 to 0.4,
b being in the range of from zero to 0.2,
c being in the range of from 0.6 to 0.75, and
d being in the range of from zero to 0.1,
M is selected from Mg, Al, Ti, Zr, Mo, W, Nb, and Ta,

$$a + b + c = 1 .$$

In each case, TM may contain traces of further metal ions, for example traces of ubiquitous metals such as sodium, iron, calcium or zinc, as impurities but such traces will not be taken into account in the description of the present invention. Traces in this context will mean amounts of 0.05 mol-% or less, referring to the total metal content of TM.

The precursors are particulate materials. In one embodiment of the present invention, precursors have an average particle diameter (D50) in the range of from 3 to 20 μm, preferably from 4 to 16 μm. The average particle diameter may be determined, e. g., by light scattering or LASER diffraction or electroacoustic spectroscopy. The above particle diameter refers to the secondary particle diameter.

The span of the particle diameter distribution of the precursor is in the range of from 0.20 to 0.33, preferably 0.21 to 0.29. The span is defined as [(D90)−(D10)]/(D50), with the values of (D90), (D50) and (D10) being determined by dynamic light scattering.

Said particulate material may have an irregular shape but in a preferred embodiment, said particulate material has a regular shape, for example spheroidal or even spherical. The aspect ratio may be in the range of from 1 and 10, preferably from 1 to 3 and even more preferably from 1 to 1.5. The aspect ratio is defined as the ratio of width to length or specifically the particle diameter in the longest dimension versus the particle diameter in the shortest dimension. Perfectly spherical particles have an aspect ratio of 1.

Step (a) includes providing at least one aqueous solution (α) containing water-soluble salts of Ni and of at least one transition metal selected from Co and Mn, and, optionally, at least one further metal selected from Ti, Zr, Mo, W, Al, Mg, Nb, and Ta, and an aqueous solution (β) containing an alkali metal hydroxide and, optionally, an aqueous solution (γ) containing a complexing agent, for example ammonia.

The term water-soluble salts of cobalt and nickel or manganese or of metals other than nickel and cobalt and manganese refers to salts that exhibit a solubility in distilled water at 25° C. of 25 g/l or more, the amount of salt being determined under omission of crystal water and of water stemming from aquo complexes. Water-soluble salts of nickel and cobalt and manganese may preferably be the respective water-soluble salts of Ni²⁺ and Co²⁺ and Mn²⁺. Examples of watersoluble salts of nickel and cobalt are the sulfates, the nitrates, the acetates and the halides, especially chlorides. Preferred are nitrates and sulfates, of which the sulfates are more preferred.

The term “water-soluble compounds of aluminum” then refers to compounds like Al₂(SO₄)₃, Al(NO₃)₃, KAl(SO₄)₂, NaAlO₂ and NaAl(OH)₄. Depending on the choice of water-soluble compound of aluminum, the pH value of aqueous solution (α) may be in the range of from 1 to 3 or above 13.

Examples of suitable compounds of Mg are MgSO₄, Mg(NO₃)₂, magnesium acetate and MgCl₂, with MgSO₄ being preferred.

Examples of suitable compounds of Ti are Ti(SO₄)₂, TiOSO₄, TiO(NO₃)₂, Ti(NO₃)₄, with Ti(SO₄)₂ being preferred.

Examples of suitable compounds of Zr are zirconium acetate, Zr(SO₄)₂, ZrOSO₄, ZrO(NO₃)₂, Zr(NO₃)₄, with Zr(SO₄)₂ being preferred.

Examples of suitable compounds of Nb are (NH₄)Nb(C₂O₄)₃ and (NH₄)NbO(C₂O₄)₂. Examples of suitable compounds of Mo are MoO₃, Na₂MoO₄, and (NH₄)₂MoO₄.

Examples of suitable compounds of W are WO₃, WO₃·H₂O, Na₂WO₄, ammonium tungstate and tungstic acid.

Solution (α) may have a pH value in the range of from 2 to 5. In embodiments wherein higher pH values are desired, ammonia may be added to solution (α). However, it is preferred to not add ammonia to solution (α). In case it is intended to provide a solution containing NaAlO₂ and NaAl(OH)₄ it is preferred to provide at least two aqueous solutions, one containing nickel and at least one of cobalt and manganese and, optionally, at least one of Ti, Zr, Mo, W, Mg, Nb, and Ta, and another aqueous solution containing NaAlO₂ or NaAl(OH)₄.

The concentration of nickel and other constituents of TM, as the case may be, can be selected within wide ranges. Preferably, the respective total metal concentration is selected to be within a range of 1 to 1.8 mol of the metal/kg of solution, more preferably 1.3 to 1.7 mol of the metal/kg of solution.

In addition, in step (a) an aqueous solution of alkali metal hydroxide is provided, hereinafter also referred to as solution (β). Examples of alkali metal hydroxides are potassium hydroxide and a combination of sodium and potassium hydroxide, and even more preferred is sodium hydroxide.

In one embodiment of the present invention, solution (β) mainly contains alkali metal hydroxide and some amount of carbonate, e.g., 0.1 to 2% by weight, referring to the respective amount of alkali metal hydroxide, added deliberately or by aging of the solution (β) or the respective alkali metal hydroxide.

Solution (β) may have a concentration of hydroxide in the range from 0.1 to 12 mol/1, preferably 6 to 10 mol/1.

The pH value of solution (β) is preferably 13 or higher, for example 14.5.

Solution (γ) contains a complexing agent. Examples of complexing agents are ammonia and organic acids or their alkali or ammonium salts wherein said organic acid bears at least two functional groups per molecule and at least one of the functional groups is a carboxylate group.

Examples of organic acids that bear two identical functional groups are adipic acid, oxalic acid, succinic acid and glutaric acid. An example of organic acids that bears three identical functional groups is citric acid.

In one embodiment of the present invention, said organic acid is selected from malic acid, tartaric acid, citric acid, and glycine.

In one embodiment of the present invention, the concentration of complexing agent(s) in solution (γ) is in the range of from1 to 30% by weight. In embodiments wherein the complexing agent is selected from ammonia its concentration is preferably in the range of from 10 to 30% by weight. In embodiments wherein the complexing agent(s) is or are selected from organic acids or their alkali or ammonium salts wherein said organic acid bears at least two functional groups per molecule and at least one of the functional groups is a carboxylate group, the concentration of said complexing agent in solution (γ) may be in the range of from 0.2 to 10% by weight.

More preferred complexing agent is ammonia.

Step (b) includes combining solution(s) (α) and solution (β) and, if applicable, solution (γ) in one or more sub-steps, in a stirred tank reactor, at a pH value in the range of from 10.5 to 12.5 determined at 23° C., thereby creating solid particles of hydroxide. Said solid particles are slurried. Step (b) is preferably performed as a discontinuous process.

In embodiments wherein step (b) is performed in a single sub-step—that may as well be termed “in a single step” or “in a single operation””, step (b) is preferably performed at a constant pH value.

In embodiments wherein step (b) is performed in at least two sub-steps, hereinafter also referred to as sub-step (b1), sub-step (b2), and, if applicable, sub-step (b3) etc., at least two substeps, for example sub-steps (b1) and (b2), are performed at different pH values, for example at a pH values that differs by 0.2 to 1.5 units, each determined at 23° C.

In one embodiment of the present invention, such sub-step (b1) includes combining solution(s) (α) and solution (β) and, if applicable, solution (γ) at a pH value in the range of from 12.0 to 12.5 determined at 23° C. in a continuously operated stirred tank reactor, thereby creating solid particles of hydroxide, said solid particles being slurried, and
sub-step (b2) includes transferring slurry from step (b) into a stirred tank reactor where a solution (α) and a solution (β) and, if applicable, a solution (γ) are combined with the slurry at a pH value in the range of from 11.0 to 12.0 determined at 23° C.,
and wherein stirred tank reactor used in sub-step (b2) is equipped with a solid-liquid separation device through which mother liquor containing slurried particles of hydroxide in the range of from 2 mg/l to 20 g/l is withdrawn.

In one embodiment of the present invention, the particles resulting from step (b1) have an average diameter (D50) in the range of from 1 to 6 μm.

In one embodiment of the present invention, the residence time of the slurry in step (b1) is in the range of from 10 minutes to 6 hours, preferably in the range from 30 minutes to 9 hours, more preferred in the range of 4 to 8 hours. Step (b1) may be performed in the continuous or discontinuous mode, discontinuous being preferred.

In one embodiment of the present invention, step (b) is performed at a temperature in the range from 10 to 85° C., preferably at temperatures in the range from 20 to 70° C.

In one embodiment of the present invention, step (b) is performed at constant pressure, for example at ambient pressure. In other embodiments, step (b) is performed at elevated pressure, for example up to 50 bar.

In one embodiment, for carrying out sub-step (b2), slurry from sub-step (b1) is transferred into a stirred tank reactor where a solution (α) and a solution (β) and, if applicable, a solution (γ) are combined with the slurry at a pH value in the range of from 11.0 to 12.0 determined at 23° C. Preferably, the pH value in sub-step (b2) is lower than in step (b1), for example by at least 0.2 units and more preferably at least 0.3 units.

Said transfer may be carried out immediately after formation of the slurry or after a time of ripening, see below, in a storage vessel.

In one embodiment of the present invention, the solids content of the slurry that is transferred to sub-step (b2)—or to the storage vessel, see below—is in the range of from 200 to 1200 g/l. Before the start-up of sub-step (b2), slurry from step (b1) is preferably diluted in the reactor wherein sub-step (b2) is performed, for example with de-ionized water or with mother liquor, to 2 to 100 g/l. The solids content may be determined by density measurements or ICP (inductively coupled plasma) or by Coriolis meters and refers to the slurried particles. Dissolved compounds such as, but not limited to Na₂SO₄ are neglected in this context.

In one embodiment of the present invention, step (b) is performed under an inert atmosphere, for example nitrogen or a rare gas such as argon. Oxygen-depleted air, for example with up to 2% by weight of O₂, is feasible as well, especially when TM does not contain manganese. Due to the strong alkalinity of solution (β), CO₂ is not a suitable atmosphere.

In one embodiment, sub-step (b2), slurry from sub-step (b1) is transferred into a batch-wise operated stirred tank reactor wherein a solution (α) and a solution (β) and, if applicable, a solution (γ) are combined with the slurry at a pH value in the range of from 11.0 to 12.0. The pH value is determined at 23° C.

Solution (α) and a solution (β) and, if applicable, solution (γ) in sub-step (b2) are defined as above. They may have the same composition over the whole time of step (b) or different—but in the framework of the definition as set out above, for example, one of them contains a watersoluble salt of nickel and at of least one of cobalt and manganese. In such cases, they are also referred to as solutions (α′) and a solution (β′) and, if applicable, solution (γ′), respectively. Preferably, however, the compositions of solutions (α) in step (b) are kept constant in composition.

Even more preferably, the compositions of solutions (α) as well as the compositions of solutions (β) are kept constant during step (b).

The stirred tank reactor used in step (b) or in particular in sub-step (b2) is equipped with a solid-liquid separation device through which mother liquor containing in the range of from 0.002 to 20 g/l of slurried particles of hydroxide is withdrawn. This means that slurried particles are removed from the stirred tank reactor together with mother liquor without being fed back.

This may be achieved by deliberately exceeding the capacity of a commercially available clarifier. In embodiments wherein membranes are used for solid-liquid separation, the mesh is selected bigger than the average particle size of hydroxide being slurried.

Particles withdrawn in the course of step (b) and in particular in sub-step (b2) may have a broad particle size distribution, for example from 0.2 to 20 μm, and they may have a span from 0.3 to 1.0.

In one embodiment, the composition of solution (α)—or (α′), as the case may be—varies in the course of sub-step (b2), for example the concentrations of nickel and cobalt or manganese. In another embodiment of the present invention, the composition of solution (α)—or (α′), as the case may be—remains constant.

In one embodiment of the present invention, the duration of sub-step (b2) is in the range of from 30 minutes to 80 hours, preferably in the range from 10 to 70 hours, more preferred in the range of 15 to 60 hours.

In one embodiment of the present invention, sub-step (b2) is performed at a temperature in the range from 10 to 85° C., preferably at temperatures in the range from 20 to 70° C.

In one embodiment of the present invention, sub-step (b2) is performed at constant pressure, for example at ambient pressure. In other embodiments, step (b) is performed at elevated pressure, for example up to 50 bar.

In one embodiment of the present invention, the inventive process is carried out in a cascade of at least two stirred tank reactors of which the first stirred tank reactor is equipped with an overflow system through which slurry is removed from the first stirred tank reactor and transferred to the second stirred tank reactor, directly or indirectly.

In a preferred embodiment, slurry is removed from the continuous stirred tank reactor in which step (b) is carried out and transferred to a stirred storage vessel where the slurry is stored under stirring for a time period of from 15 minutes to 24 hours, preferably from 30 minutes to 10 hours, before being transferred to the second stirred tank reactor. Said operation is also referred to as storage step. In the course of the storage step, neither solution (α) nor solution (β) nor solution (γ) is added. Said storage is preferably under inert gas, vide supra.

In one embodiment of the present invention, the temperature during the storage step is in the range of from 20 to 70° C., preferably 30 to 70° C.

In one embodiment of the present invention, the pH value of the slurry in the storage vessel is in the range of from 10.0 to 13.0 determined at 23° C., preferably from 11.0 to 12.0.

In one embodiment of the present invention, at the same time in the range of from 5 to 30 vol %, preferably 10 to 20 vol-% of slurry are in the storage vessel and 70 to 95 vol-%, preferably 80 to 90 vol-% of slurry are in the tank reactor(s) wherein step (b) is performed. In this context, the amount of slurry being located in any piping or related part is neglected.

In one embodiment of the present invention, the slurry in the storage vessel is occasionally stirred, for example with an average energy input of from 0.2 to 1 W/I. Said occasional stirring is useful for avoiding sedimentation of the solids of the slurry.

Further steps may be performed subsequently to sub-step (b2), for example, work-up steps I.

An example of work-up steps I is to remove the particles of (oxy)hydroxide by a solid-liquid separation method, for example filtration.

In such a step I, the particles from sub-step (b2) are separated from the liquid phase by a solid-liquid separation method, preferably by filtration or in a centrifuge. The liquid phase may also be termed mother liquor. Filtration may be performed, e.g., on a belt filter or in a filter press.

In order to remove mother liquor, it is preferred to wash the filter cake, for example with water or with alkali metal hydroxide or alkali metal carbonate solution.

Filtration may be supported by suction or by pressure.

Step I may be performed at any temperature at which water is in the liquid state, for example 5 to 95° C., preferred is 20 to 60° C.

By performing step I, a solid material is obtained which is a particulate (oxy)hydroxide or oxide of TM. Said material usually has a high water content, for example 1 to 30% by weight, and may be dried, e.g. at air, at a temperature in the range of from 80 to 150° C., or at reduced pressure (“in vacuo”), to a moisture content in the range of from 100 to 5,000 ppm, ppm being ppm by weight. The water content may be determined by drying in vacuo at a temperature of 100° C. until the weight is remaining unchanged. The moisture content may be determined by Karl-Fischer titration.

Subsequently to step I or to drying, said particulate (oxy)hydroxide or oxide of TM may be subjected to a step (d). Step (d) includes a thermal treatment of the solid from step I in a rotary kiln or in a flash calciner.

In one embodiment of step (d), the wet solid material is introduced into the rotary kiln by a chute or a vibrating chute, by a spiral conveyor or a screw conveyor, preferably by a screw conveyor with a single screw or multiple screws.

A further aspect of the present invention refers to particulate (oxy)hydroxide of TM, hereinafter also referred to as inventive (oxy)hydroxides or inventive precursors. Inventive precursors are advantageously made according to the inventive process.

In inventive (oxy)hydroxide, TM refers to a combination of nickel with of at least one metal selected from cobalt and manganese, wherein said inventive (oxy)hydroxide has an average particle diameter (d50) in the range of from 3 to 20 μm, preferably 4 to 16 μm, and a core-shell structure wherein both core and shell show an essentially radial alignment of platelet-shaped primary particles, and wherein core and shell are separated by a porous layer that contains randomly arranged primary particles.

The porous layer may be detected by scanning electron microscopy (“SEM”) or transmission electron microscopy (“TEM”). In said porous layer, usually only few voids may be detected.

Preferably, said porous layer between core and shell has an average thickness in the range of from 0.1 to 1.0 μm.

The portion of radially aligned primary particles may be determined, e.g., by SEM (Scanning Electron Microscopy) of a cross-section of at least 5 secondary particles.

“Essentially radially alignment” does not require a perfect radial orientation but includes that in an SEM analysis, a deviation to a perfectly radial orientation is at most 5 degrees.

Furthermore, at least 70% of the secondary particle volume is filled with radially oriented primary particles. Preferably, only a minor inner part, for example at most 30%, preferably at most 20%, of the volume of those particles is filled with non-radially oriented primary particles, for example, in random orientation.

In the porous layer, preferably the share of voids is more than 10% if determined by choosing 5 representative particles in SEM and calculating the Inventive (oxy)hydroxides have a particle size distribution with a span [(D90)−(D10)]/(D50) in the range of from 0.2 to 0.33, preferably from 0.21 to 0.29. The diameters (D10), (D50) and (D90) may be determined by dynamic light scattering and refer to the respective percentiles.

In one embodiment of the present invention, TM in inventive (oxy)hydroxides is a combination of metals according to general formula (I)

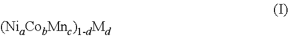

with
a being in the range of from 0.6 to 0.95, preferably from 0.8 to 0.94,
b being in the range of from 0.025 to 0.2,
c being in the range of from zero to 0.2, and
d being in the range of from zero to 0.1,
M is selected from Mg, Al, Ti, Zr, Mo, W, Al, Mg, Nb, and Ta,

$$a + b + c = 1 .$$

In another embodiment of the present invention, TM in inventive (oxy)hydroxides is a combination of metals according to general formula (I a)

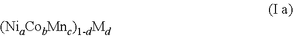

with
a being in the range of from 0.25 to 0.4,
b being in the range of from zero to 0.2,
c being in the range of from 0.6 to 0.75, and
d being in the range of from zero to 0.1,
M is selected from Mg, Al, Ti, Zr, Mo, W, Al, Mg, Nb, and Ta,

$$a + b + c = 1 .$$

Inventive (oxy)hydroxides are preferably obtained according to the inventive process.

Inventive (oxy)hydroxides are excellent precursors for cathode active materials which are suitable for producing batteries with a high volumetric energy density and excellent cycling stability.

Such cathode active materials are made by mixing with a source of lithium, e.g., LiOH or Li₂O₂ or Li₂CO₃, followed by calcination, for example at a temperature in the range of from 600 to 1000° C. Especially in embodiments wherein TM of inventive (oxy)hydroxides corresponds to formula (I), said calcination is preferably performed in an atmosphere of oxygen or oxygenenriched air, for example with at least 60 vol-% of oxygen, preferably 80 vol-% of oxygen and more preferably at least 90 vol-% oxygen. In embodiments wherein TM of inventive (oxy)hydroxides corresponds to formula (I a), said calcination may be performed in air atmosphere.

Examples of suitable set-ups for said calcination are rotary kilns, roller hearth kilns, and pusher kilns.

In one embodiment of the present invention, the temperature is ramped up before reaching the desired temperature of from 700 to 1000° C., preferably 750 to 900° C. For example, first the mixture of precursor and source of lithium and oxide or hydroxide of Al is heated to a temperature to 350 to 550° C. and then held constant for a time of 10 min to 4 hours, and then it is raised to 650° C. up to 1000° C., preferably 650 to 850° C.

In embodiments wherein in the mixing step at least one solvent has been used, as part of step such solvent(s) are removed, for example by filtration, evaporation or distilling of such solvent(s). Preferred are evaporation and distillation.

In one embodiment of the present invention, said calcination is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

By performing the inventive calcination process cathode active materials with excellent properties and a narrow particle size distribution are available through a straightforward process. Preferably, the electrode active materials so obtained have a specific surface (BET) in the range of from 0.1 to 0.8 m²/g, determined according to DIN-ISO 9277:2003-05.

A further aspect of the present invention relates to cathode active materials, hereinafter also referred to as inventive cathode active materials. Inventive cathode active materials are described by the chemical formula Li1₊ₓTM₁₋ₓO₂, with TM being defined as above and x being in the range of from zero to 0.05, preferably 0.01 to 0.03, and they have a span in the range of from 0.20 to 0.33, preferably 0.21 to 0.29.

By performing a calcination in the above way, the essentially radial alignment of primary particles is—e.g., to at least 80%, preferably to at least 90%—retained, and cathode active materials with excellent capacity retention are obtained.

A further aspect of the present invention refers to electrodes and specifically to cathodes, hereinafter also referred to as inventive cathodes. Inventive cathodes comprise
(A) at least one inventive cathode active material,
(B) carbon in electrically conductive form,
(C) at least one binder.

In a preferred embodiment of the present invention, inventive cathodes contain
(A) 80 to 99% by weight inventive cathode active material,
(B) 0.5 to 19.5% by weight of carbon,
(C) 0.5 to 9.5% by weight of binder polymer,
percentages referring to the sum of (A), (B) and (C).

Cathodes according to the present invention contain carbon in electrically conductive modification, in brief also referred to as carbon (B). Carbon (B) can be selected from soot, active carbon, carbon nanotubes, graphene, and graphite. Carbon (B) can be added as such during preparation of electrode materials according to the invention.

Electrodes according to the present invention can comprise further components. They can comprise a current collector (D), such as, but not limited to, an aluminum foil. They further comprise a binder polymer (C), hereinafter also referred to as binder (C). Current collector (D) is not further described here.

Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight MW in the range from 50,000 to 1,000,000 g/mol, preferably to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

A further aspect of the present invention is an electrochemical cell, containing
(1) a cathode comprising inventive cathode active material (A), carbon (B), and binder (C),
(2) an anode, and
(3) at least one electrolyte.

Embodiments of cathode (1) have been described above in detail.

Anode (2) may contain at least one anode active material, such as carbon (graphite), TiO₂, lithium titanium oxide, silicon or tin. Anode (2) may additionally contain a current collector, for example a metal foil such as a copper foil.

Electrolyte (3) may comprise at least one non-aqueous solvent, at least one electrolyte salt and, optionally, additives.

Non-aqueous solvents for electrolyte (3) can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight MW of suitable polyalkylene glycols and in particular suitable polyethylene glycols can be at least 400 g/mol.

The molecular weight MW of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and, in particular, 1,3-dioxolane.

Examples of suitable acyclic organic carbonates are dimethyl carbonate, ethyl methyl carbonate and diethyl carbonate.

Examples of suitable cyclic organic carbonates are compounds of the general formulae (II) and (III)

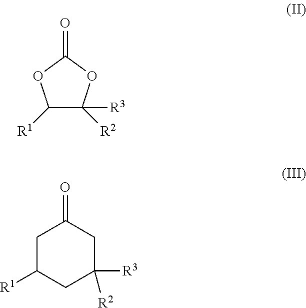

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

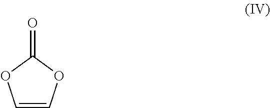

The solvent or solvents is/are preferably used in the water-free state, i.e. with a water content in the range from 1 ppm to 0.1% by weight, which can be determined, for example, by Karl-Fischer titration.

Electrolyte (3) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CnF₂ₙ₊₁SO₂)₃, lithium imides such as LiN(CnF₂ₙ₊₁SO₂)₂, where n is an integer in the range from 1 to 20, LiN(SO₂F)₂, Li₂SiF₆, LiSbF₆, LiAlCl₄ and salts of the general formula (CnF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In a preferred embodiment of the present invention, electrolyte (3) contains at least one flame retardant. Useful flame retardants may be selected from trialkyl phosphates, said alkyl being different or identical, triaryl phosphates, alkyl dialkyl phosphonates, and halogenated trialkyl phosphates. Preferred are tri-C₁-C₄-alkyl phosphates, said C₁-C₄-alkyls being different or identical, tribenzyl phosphate, triphenyl phosphate, C₁-C₄-alkyl di-C₁-C₄-alkyl phosphonates, and fluorinated tri-C₁-C₄-alkyl phosphates,

In a preferred embodiment, electrolyte (3) comprises at least one flame retardant selected from trimethyl phosphate, CH₃—P(O)(OCH₃)₂, triphenylphosphate, and tris-(2,2,2-trifluoroethyl)phosphate.

Electrolyte (3) may contain 1 to 10% by weight of flame retardant, based on the total amount of electrolyte.

In an embodiment of the present invention, batteries according to the invention comprise one or more separators (4) by means of which the electrodes are mechanically separated. Suitable separators (4) are polymer films, in particular porous polymer films, which are unreactive toward metallic lithium. Particularly suitable materials for separators (4) are polyolefins, in particular film-forming porous polyethylene and film-forming porous polypropylene. Separators (4) composed of polyolefin, in particular polyethylene or polypropylene, can have a porosity in the range from 35 to 50%. Suitable pore diameters are, for example, in the range from 30 to 500 nm.

In another embodiment of the present invention, separators (4) can be selected from among PET nonwovens filled with inorganic particles. Such separators can have a porosity in the range from 40 to 55%. Suitable pore diameters are, for example, in the range from 80 to 750 nm.

Batteries according to the invention can further comprise a housing which can have any shape, for example cuboidal or the shape of a cylindrical disk. In one variant, a metal foil configured as a pouch is used as housing.

Batteries according to the invention provide a very good discharge and cycling behavior, in particular at high temperatures (45° C. or higher, for example up to 60° C.) in particular with respect to the capacity loss.

Batteries according to the invention can comprise two or more electrochemical cells that combined with one another, for example can be connected in series or connected in parallel. Connection in series is preferred. In batteries according to the present invention, at least one of the electrochemical cells contains at least one electrode according to the invention. Preferably, in electrochemical cells according to the present invention, the majority of the electrochemical cells contain an electrode according to the present invention. Even more preferably, in batteries according to the present invention all the electrochemical cells contain electrodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

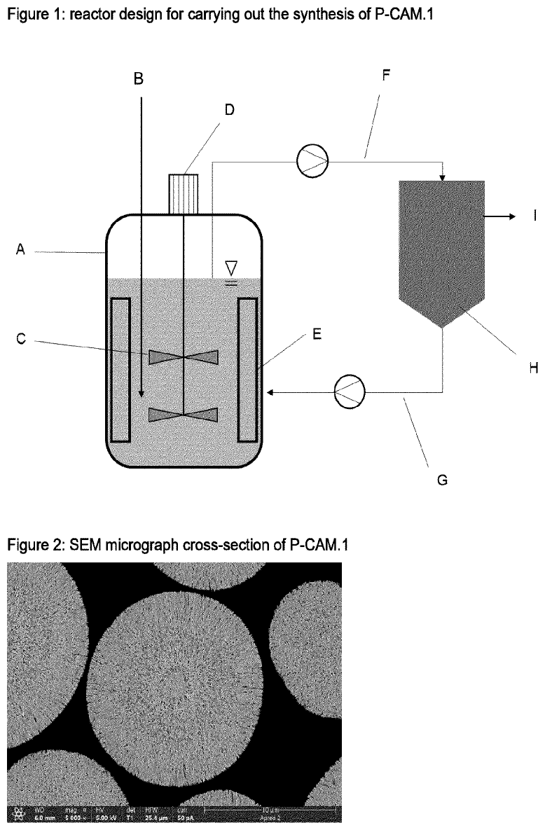

The present invention is further illustrated by working examples and a drawing, see FIG. 1.

All co-precipitations were performed in a 17-liter stirred tank reactor equipped with four inlets but no overflow system under an atmosphere of N₂ that was constantly replenished during step (a). All aqueous solutions were made with de-ionized water. All precipitations were performed under stirring. On regular base, aliquots of the slurries were analyzed for particle diameter.

### BRIEF DESCRIPTION OF THE DRAWING

FIG. 1: Set-up for performing the inventive process and the comparative process
A: 800-1-tank reactor
B: feed inlet for solutions (α.1), (β.1), (γ.1)) [simplified drawing]
C: stirrer blades of a two-stage pitch-blade turbine (45° angle, diameter 0.4 m)
D: engine for stirrer
E: baffle
F: transfer suspension from reactor to clarifier
G: transfer suspension from clarifier to reactor
H: lamella clarifier
I: particle containing mother liquor withdrawn from the reactor through the overflow of the lamella clarifier
F: aqueous cobalt sulfate solution feed inlet, solution (α2.1)

### WORKING EXAMPLES

### General

A Mastersizer 3000 from Malvern Panalytical GmbH was used. The sample was filled into the device until a light obscuration between 4.0-14.0% was achieved. The respective volume-based particle size distribution (PSD) was determined by laser diffraction based on Mie's scattering theory. A refractive index of 1.33 for H₂O as dispersant was selected, while a refractive index of 2.19 of the solid phase was selected.

### I. Manufacture of Inventive and Comparative Precursors

### I.1 General, Step (a)

Percentages refer to % by weight unless expressly noted otherwise. All pH value determinations were performed at 23° C. unless expressly mentioned otherwise
rpm: revolutions per minute

The following aqueous solutions were provided:
Solution (α.1): NiSO₄, CoSO₄ and MnSO₄ dissolved in deionized water (molar ratio 91:4.5:4.5, total transition metal concentration: 1.45 mol/kg)
Solution (α.2): NiSO₄, CoSO₄ and MnSO₄ dissolved in deionized water (molar ratio 83:12:5, total transition metal concentration: 1.45 mol/kg)
Solution (β.1): 25 wt % NaOH dissolved in deionized water
Solution (γ.1): 25 wt % ammonia in deionized water

### I.2 Manufacture of the Inventive Precursor P-CAM.1

### I.2.1 Manufacture of a Slurry of Seeds, Step (b1.1):

A 50 L stirred vessel equipped with baffles and a three-stage pitch-blade stirrer (45° blade angle) with a diameter of 0.21 m was charged with 40 liters of de-ionized water. The stirrer element was activated to reach an average energy dissipation of 0.8 W/l and the water was heated to 55° C. Afterwards, solution (γ.1) was added to reach an NH₃ concentration of 0.23 w %. Then, the pH of the solution was adjusted to 12.2 by adding solution (β.1).

Then, the stirrer rotation speed was increased and constantly operated at 420 rpm (average energy input ˜12.6 W/1). Subsequently, feeding of solutions (α.1), (β.1) and (γ.1) was started simultaneously. The total flow of feeds was adjusted to reach an average residence time of 7.5 hours. The molar ratio between ammonia and metal was adjusted to 0.17. The flow rate of the NaOH was adjusted by a pH value regulation circuit to keep the pH value in the vessel at a constant value of 12.35. The apparatus was operated continuously keeping the liquid level in the reaction vessel constant. The resulting seed suspension for step (b1.2) was collected via free overflow from the vessel. The resulting slurry contained about 110 g/l mixed hydroxide of Ni, Co and Mn with an average particle size (D50) of 3.9 μm and a span of 1.28.

### I.2.2 Precipitation, Step (b2.1)

The set-up according to FIG. 1 was charged with 680 l de-ionized water so that both stirrer stages were submersed. The stirrer speed was adjusted to 130 rpm (0.36 W/L) while the water was heated via the double jacket to 55° C. The temperature was remained constant at 55° C. during the complete batch. Then, 20.9 kg of solution (β.1) were added. As a next step, 43 kg of slurry of seeds from step (b1.1) was added to the mixture leading to an initial solid content of approx. 5 g/l. The pH value after addition of all feeds was 11.65. Subsequently, the stirrer speed was adjusted to 396 rpm (corresponds to 7.9 W/1), and the feed of solutions (α.1), (β.1), and (γ.1) was started simultaneously. The stirrer speed was stepwise decreased during the batch synthesis to a final stirrer speed of 220 rpm (1.65 W/L). The pH value was kept constant at 11.5 by adjusting the addition of solutions (β.1) and (γ.1) to obtain a NH₃ concentration in mother liquor of 0.7 w %. The ratio between reactor volume (800 l) and volume flow of total feeds (residence time equivalent) was started in a way that an average residence time of 40 hours would have resulted. However, the feeds were ramped-up during the synthesis to a final residence time equivalent of 5 hours.

The clarifier was empty at the beginning. After a reaction time of one hour, suspension transfer to the clarifier was started with a volume flow of 360 L/h. 10 minutes later, suspension transfer from clarifier back to the reactor was started with a volume flow of 340 L/h. The volume flows of suspension transfer to clarifier and back to the reactor were adjusted during above mentioned feed ramp to keep reactor volume constant at 800 L during the complete synthesis.

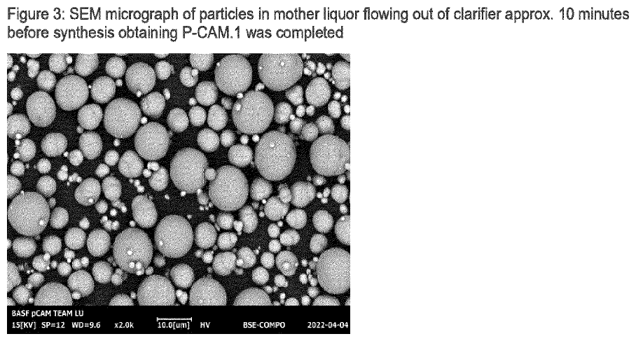

Once the clarifier was filled (after approx. 6 h), particles containing mother liquor was flowing out of the tank reactor. The average particle content of the mother liquor withdrawn through the overflow of the lamella clarifier amounted 32 mg/l during the synthesis. The average size (D50) of particles present in withdrawn mother liquor was 7.6 μm. An SEM micrograph of the particles in the withdrawn mother liquor volume at end of the synthesis can be found in FIG. 3.

The complete synthesis duration was 23.5 h leading to a solids content in the reactor of 382 g/L, measured via H₂SO₄ dissolution of suspension and subsequent ICP analysis of Ni, Co, Mn.

After completion of the batch all feed flows were stopped and reactor and clarifier were discharged to a stirred suspension buffer vessel and the slurry was filtered using a filter press. The filter cake was washed with solution (β.1) and de-ionized water and dried at 120° C. for 14 hours to obtain the precursor P-CAM.1 with a molar composition of Ni:Co:Mn=91:4.5:4.5, an average particle size (d50)=13.9 μm and span=0.31. The cross-section SEM picture of P-CAM.1 shows a core-shell structure containing essentially radially aligned primary particles. Between core and shell a small porous layer is visible.

### I.3 Manufacture of the Comparative Precursor, C-P-CAM.2

The protocol of example P-CAM.1 was followed to a certain extent while different feed flows were applied. The ratio between reactor volume (800 l) and volume flow of total feeds (residence time equivalent) was started with 40 hours and feeds were ramped-up during the synthesis to a final residence time equivalent of 9 hours. The lower feed flows resulted in a lower hydraulic load of the clarifier leading to a different solid-liquid separation behavior. The average particle content of the mother liquor withdrawn through the overflow of the lamella clarifier amounted to 1.4 mg/l during the synthesis.

The complete synthesis duration was 43.7 h leading to a final solid content in the reactor of 396 g/L, measured via H₂SO₄ dissolution of suspension and subsequent ICP analysis of Ni, Co, Mn.

After completion of the batch all feed flows were stopped and reactor and clarifier were discharged to a stirred suspension buffer vessel and the slurry was filtered using a filter press. The filter cake was washed with solution (β.1) and DI water and dried at 120° C. for 14 hours to obtain the precursor C-P-CAM.2 with a molar composition of Ni:Co:Mn=91:4.5:4.5, an average particle size (D50)=14.0 μm and span=0.37.

### I.4 Manufacture of the Inventive Precursor P-CAM.3

I.4.1 Manufacture of Slurried Seeds, Step (b1.3) The protocol of step (b1.1) was followed but solution (α.2) was used instead of solution (α.1).

The resulting slurry contained about 110 g/l mixed hydroxide of Ni, Co and Mn with an average particle diameter (D50) of 4.0 μm and a span of 1.32.

### I.4.2 Manufacture of Slurried Seeds, Step (b2.3)

The protocol of step (b2.1) was followed but solution (α.2) was used instead of (α.1). The average particle content of the mother liquor withdrawn through the clarifier amounted 42 mg/l during the step (b2.3). The average diameter (D50) of particles present in withdrawn mother liquor was 7.2 μm.

The complete synthesis duration was 22.7 h leading to a solids content in the reactor of 374 g/L, measured via H₂SO₄ dissolution of suspension and subsequent ICP analysis of Ni, Co, Mn.

After completion of the batch all feed flows were stopped and reactor and clarifier were discharged to a stirred suspension buffer vessel and the slurry was filtered using a filter press. The filter cake was washed with solution (β.1) and de-ionized water and dried at 120° C. for 14 hours to obtain the precursor P-CAM.2 with a molar composition of Ni:Co:Mn=83:12:5, an average particle size (D50)=14.1 μm and span=0.27. The cross-section SEM picture of P-CAM.3 shows a core-shell structure containing essentially radially aligned primary particles. Between core and shell a small porous layer is visible.

### I.5 Manufacture of the Comparative Precursor, C-P-CAM.4

The protocol of example C-P-CAM.2 was essentially followed. The average particle content of the mother liquor withdrawn through the clarifier amounted to 1.2 mg/l during the synthesis.

The complete synthesis during was 41.6 h leading to a final solid content in the reactor of 381 g/L, measured via H₂SO₄ dissolution of suspension and subsequent ICP analysis of Ni, Co, Mn.

After completion of the batch all feed flows were stopped and reactor and clarifier were discharged to a stirred suspension buffer vessel and the slurry was filtered using a filter press. The filter cake was washed with solution (β.1) and de-ionized water and dried at 120° C. for 14 hours to obtain the precursor C-P-CAM.4 with a molar composition of Ni:Co:Mn=83:12:5, an average particle size (d50)=13.8 μm and span=0.36.

### II. Synthesis of Cathode Active Materials

### II.1 Manufacture of Inventive CAM.1

P-CAM.1 was mixed with LiOH in a molar ratio Li/TM of 1.04 and calcined in a laboratory Linn furnace for 8 hours at 765° C. After natural cooling to ambient temperature, the resultant CAM.1 was deagglomerated in a lab mill. The resulting CAM.1 had an average particle size of 13.7 μm and a span of 0.30.

### II.2 Manufacture of Comparative C-CAM.2

C-P-CAM.2 was mixed with LiOH in a molar ration Li/TM of 1.04 and calcined in a laboratory Linn furnace for 8 hours at 765° C. After natural cooling to ambient temperature, the resultant CCAM.2 was deagglomerated by a lab mill. The resulting C-CAM.2 had an average particle size of 13.9 μm and a span of 0.36.

In electrochemical cells/lithium ion batteries, cathodes containing CAM.1 had superior properties compared to cathodes containing C-CAM.2.

### II.3 Manufacture of Inventive CAM.3

P-CAM.3 was mixed with LiOH in a molar ratio Li/TM of 1.04 and calcined in a laboratory Linn furnace for 8 hours at 780° C. After natural cooling to ambient temperature, the resultant CAM.1 was deagglomerated in a lab mill. The resulting CAM.3 had an average particle size of 13.9 μm and a span of 0.26.

### II.4 Manufacture of Comparative C-CAM.4

C-P-CAM.4 was mixed with LiOH in a molar ratio Li/TM of 1.04 and calcined in a laboratory Linn furnace for 8 hours at 780° C. After natural cooling to ambient temperature, the resultant CCAM.4 was deagglomerated in a lab mill. The resulting C-CAM.2 had an average particle size of 13.6 μm and a span of 0.35.

In electrochemical cells/lithium-ion batteries, cathodes containing CAM.3 had superior properties compared to cathodes containing C-CAM.4.

1. A process for making a particulate (oxy)hydroxide of TM wherein refers to a combination of metals according to general formula (I) or (I a) 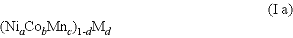
with
a being in the range of from 0.6 to 0.95,
b being in the range of from 0.025 to 0.2,
c being in the range of from zero to 0.2, and
d being in the range of from zero to 0.1, 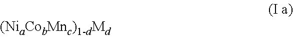
with
a being in the range of from 0.25 to 0.4,
b being in the range of from zero to 0.2,
c being in the range of from 0.6 to 0.75, and
d being in the range of from zero to 0.1,
and wherein in each case
M is selected from the group consisting of Mg, Al, Ti, Zr, Mo, W, Al, Mg, Nb, and Ta,
$$a + b + c = 1 ,$$
and wherein said process comprises the steps of:
(a) providing one or more aqueous solution(s) (α) containing water-soluble salts of Ni and of at least one transition metal selected from the group consisting of Co and Mn, and, optionally, at least one further metal selected from the group consisting of Ti, Zr, Mo, W, Al, Mg, Nb, and Ta, and an aqueous solution (0) containing an alkali metal hydroxide and, optionally, an aqueous solution (γ) containing a complexing agent,
(b) combining in a stirred tank reactor solution(s) (α) and solution (β) and, if applicable, solution (γ) in one or more sub-steps, at a pH value in the range of from 10.5 to 12.5 determined at 23° C., thereby creating solid particles of hydroxide, said solid particles being slurried,
wherein the stirred tank reactor used in step (b) or in at least one of the sub-steps (b) is equipped with a solid-liquid separation device through which mother liquor containing slurried particles of hydroxide in the range of from 2 mg/l to 20 g/l is withdrawn.

2. The process according to claim 1 wherein step (b) is carried out in two or more sub-steps, (b1) and (b2), wherein
sub-step (b1) includes combining solution(s) (α) and solution (β) and, if applicable, solution (γ) at a pH value in the range of from 12.0 to 12.5 determined at 23° C. in a continuously operated stirred tank reactor, thereby creating solid particles of hydroxide, said solid particles being slurried, and
sub-step (b2) includes transferring slurry from step (b) into a stirred tank reactor where a solution (α) and a solution (β) and, if applicable, a solution (γ) are combined with the slurry at a pH value in the range of from 11.0 to 12.0 determined at 23° C.,
and wherein the stirred tank reactor used in sub-step (b2) is equipped with a solid-liquid separation device through which mother liquor containing slurried particles of hydroxide in the range of from 2 mg/l to 20 g/l is withdrawn.

3. The process according to claim 1 wherein the average particle diameter (D50) of precursor removed in step (b) is in the range of from 0.5 to 20 μm.

4. The process according to claim 1 wherein in step (b), a clarifier or at least one candle filter is used for mother liquor withdrawal.

5. A particulate (oxy)hydroxide of TM wherein TM refers to a combination of metals according to general formula (I) or (I a), 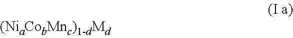
with
a being in the range of from 0.6 to 0.95,
b being in the range of from 0.025 to 0.2,
c being in the range of from zero to 0.2, and
d being in the range of from zero to 0.1, 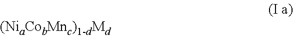
with
a being in the range of from 0.25 to 0.4,
b being in the range of from zero to 0.2,
c being in the range of from 0.6 to 0.75, and
d being in the range of from zero to 0.1,
and wherein in each case
M is selected from the group consisting of Mg, Al, Ti, Zr, Mo, W, Al, Mg, Nb, and Ta,
$$a + b + c = 1 ,$$
wherein said particulate (oxy)hydroxide has an average particle diameter (d50) in the range of from 3 to 20 μm and a core-shell structure wherein both core and shell show an essentially radial alignment of platelet-shaped primary particles and wherein core and shell are separated by a porous layer that contains randomly arranged primary particles, and wherein said particulate (oxy)hydroxide has a particle size distribution with a span [(D90)−(D10)]/(D50) in the range of from 0.2 to 0.33.

6. The particulate (oxy)hydroxide according to claim 5 wherein the porous layer between core and shell has an average thickness in the range of from 0.1 to 1.0 μm.

7. The particulate (oxy)hydroxide according to claim 5 wherein the span is in the range of from 0.21 to 0.29.

8. The process for making a cathode active material comprising the steps of mixing a particulate (oxy)hydroxide according to claim 5 with a source of lithium and, if applicable, a hydroxide or oxide of at least one of Mg, Al, Ti, Zr, Ta, Nb, Mo, or W, followed by calcination at a temperature in the range of from 700 to 900° C.

9. The process for making a cathode active material comprising the steps of heating a particulate (oxy)hydroxide according to claim 5 in the absence of a source of lithium to a temperature in the range of from 400 to 600° C., thereby obtaining an oxide of TM, followed by mixing the resultant oxide of TM with a source of lithium and, if applicable, a hydroxide or oxide of at least one of Mg, Al, Ti, Zr, Ta, Nb, Mo, or W, followed by calcination at a temperature in the range of from 700 to 900° C.

10. A particulate cathode active material according to general formula Li₁₊ₓTM₁₋ₓO₂ wherein TM refers to a combination of metals according to general formula (I) or (Ia), 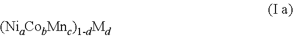
with
a being in the range of from 0.6 to 0.95,
b being in the range of from 0.025 to 0.2,
c being in the range of from zero to 0.2, and
d being in the range of from zero to 0.1, 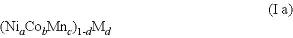
with
a being in the range of from 0.25 to 0.4,
b being in the range of from zero to 0.2,
c being in the range of from 0.6 to 0.75, and
d being in the range of from zero to 0.1,
and wherein in each case
M is selected from the group consisting of Mg, Al, Ti, Zr, Mo, W, Al, Mg, Nb, and Ta,
$$a + b + c = 1 ,$$
wherein x is in the range of from zero to 0.03, and wherein said cathode active material has an average particle diameter (D50) of from 3 to 20 μm, and a particle size distribution with span [(D90)−(D10)]/(D50) in the range of from 0.20 to 0.33.

11. The particulate cathode active material according to claim 10 wherein the span is in the range of from 0.21 to 0.29.

12. A cathode comprising
(A) at least one cathode active material according to claim 10,
(B) carbon in electrically conductive form, and
(C) at least one binder.

13. (canceled)

14. (canceled)

15. (canceled)

16. (canceled)

17. (canceled)
